(19) United States
(12) Patent Application Publication
(10) Pub. No.: US 2018/0301698 A1
(43) Pub. Date: Oct. 18, 2018

(54) Carboxylic Acids As Surface Modifier for Improved Electrode

(71) Applicant: Rhode Island Council on Postsecondary Education, Warwick, RI (US)

(72) Inventors: Brett L. LUCHT, Kingston, RI (US); Cao Cuong NGUYEN, Kingston, RI (US); K.W.D.K. CHANDRASIRI, Kingston, RI (US); Daniel SEO, North Kingstown, RI (US)

(21) Appl. No.: 15/954,412

(22) Filed: Apr. 16, 2018

Related U.S. Application Data
(60) Provisional application No. 62/485,828, filed on Apr. 14, 2017.

(51) Int. Cl. H01M 4/36; H01M 4/134; H01M 4/133; H01M 4/04; H01M 10/0525

(52) U.S. Cl. CPC H01M 4/366; H01M 4/134; H01M 2004/027; H01M 4/0404; H01M 10/0525; H01M 4/133

(57) ABSTRACT

The present invention provides novel and inexpensive compositions including carboxylic acids as an efficient surface-modifying agent for a silicon-based electrode, useful in constructing a novel lithium ion secondary battery.

### CROSS-REFERENCE TO RELATED APPLICATIONS

This application claims priority to and the benefit of co-pending U.S. provisional patent application Ser. No. 62/485,828, filed Apr. 14, 2017, which application is incorporated herein by reference in its entirety.

### STATEMENT REGARDING FEDERALLY SPONSORED RESEARCH OR DEVELOPMENT

This invention was made with government support under DE-SC0007074 awarded by the U.S. Department of Energy. The government has certain rights in the invention.

### FIELD OF INVENTION

The present invention relates to materials and methods for making an electrode for a rechargeable or secondary battery, more specifically, a lithium ion secondary battery.

### BACKGROUND OF THE INVENTION

The rapid development of portable electronic devices such as smartphones, tablets and laptops requires a new generation of lithium ion batteries (LiBs) with higher energy density. High energy LiBs are also urgently needed to increase the driving range of electric and hybrid vehicles. Graphite is the most common anode used in commercial LiBs, but graphite has a moderate theoretical capacity of 372 mAh/g. Much attention has been devoted to the development of silicon (Si) anodes for lithium ion batteries, due to its much higher theoretical capacity at 3579 mAh/g (Obrovac, M. N. et al., Chem. Rev. 2014, 114, 11444-11502).

However, large volume changes of Si during cycling (up to 400% change) tend to lead to the pulverization of active particles and loss of electrical contact between electrode components (Ryu, J. H. et al., Electrochem. Solid-State Lett. 2004, 7, A306-A309). Furthermore, this enormous morphology change causes the continuous breakdown of the solid electrolyte interphase (SEI) on the silicon-based surface. The reformation of the SEI consumes electrolyte and active lithium, which can result in complete electrolyte consumption and cells drying out (Beattie, S. D. et al. J. Power Sources 2016, 302 (January), 426-430). The combination of these detrimental reactions leads to rapid capacity loss for silicon-based electrodes.

Modification of the SEI using sacrificial additives such as fluoroethylene carbonate (FEC), vinylene carbonate (VC) or methylene ethylene carbonate (MEC) is one of the recent methods to improve cycling performance of Si nanoparticle electrodes (e.g., Etacheri, V. et al., Langmuir 2011, 28, 965-976). These additives are reduced on surface of silicon to form a more robust SEI mainly consisted of poly(carbonate) and inorganic salts such as lithium carbonate and lithium fluoride. This SEI was found to be effective in passivating the surface of silicon electrodes and suppressing the reduction of solvents such as EC, thereby resulting in less lithium alkyl carbonate (Nguyen, C. C. et al., Electrochem. Commun. 2016, 66, 71-74).

Others have turned their attention to another vital component, the polymer binder, for maintaining the integrity of the electrode structure (e.g., Nguyen, C. C. et al., ACS Appl. Mater. Interfaces 2016, 8, 12211-12220). The choice of binder has a large effect on the cycling performance of Si-based electrodes. For example, existing silicon-based electrode has exhibited poor cycling performance with poly(vinylidene difluoride) (PVDF), the most widely used binder in LiBs (Li, J. et al., Electrochem. Solid-State Lett. 2007, 10, A17-A20). To improve the binder, researchers have tried to either improve the mechanical strength and/or adhesion capacity of the binder material (e.g., U.S. Patent Application Publication No. 20130101897).

In sum, stress-induced problems stemming from volume variations in silicon-based electrodes during the lithiation and delithiation process (i.e., charging-discharging cycle) persist as a key obstacle facing such electrode's wide commercial adoption in lithium ion battery construction. While significant progress has been made in enhancing the mechanical strength and/or adhesion ability of the binder, there remains the need to find additional ways to construct better lithium ion batteries as well as other electrode-containing devices with the goal of improving the battery's cycling performance.

### SUMMARY OF THE INVENTION

The present invention provides methods and compositions that improve the cycle profile/characteristics of the lithium ion secondary battery where the electrode active material contains a silicon-based material. Improvements in the cycle characteristics may involve aspects measured in relation to specific capacity profile, charging efficiency, capacity retention percentage, and so on. Specifically, the present invention provides improvement in mechanical properties of the silicon-based electrode through surface modification, the process of which provides additional protection to the electrode and possibly affects the binder material.

The electrode for a lithium ion secondary battery or a similarly rechargeable battery, according to the present invention, is characterized in that carboxylic acid is used to coat or encapsulate and thereby modify the surface of a silicon-based electrode active material and provide a pre-SEI layer over the surface of such material. In one feature, the electrode is the anode, or negative electrode. This modification step takes place prior to the material (e.g., a plurality of silicon-based nanoparticles or microparticles) being mixed with the rest of the constituents for the electrode, e.g., graphite, a conductive auxiliary agent such as a conductive carbon, and a polymeric binder, to form the electrode when these materials are affixed to a current collector.

Accordingly, in one aspect, the present invention provides an electrode for a lithium ion secondary battery that includes: (1) an electrode active material comprising a silicon-based material, such as silicon, silicon dioxide, silicon-graphite composite, and combinations thereof; (2) a surface modifier comprising, or, alternately, consisting essentially of, carboxylic acid (i.e., carboxylic acid being the sole constituent that is chemically reactive with the silicon-based electrode active material). The surface-modified electrode active material, upon interaction with electrolyte, forms a solid electrolyte interphase that protects the electrode from further reduction of the electrolyte and improves the cycling performance and battery life. The electrode active material is adhered to a current collector via a binder. The binder, in various embodiments of the invention, is preferably a polymeric material, such as poly(vinylidene difluoride) (PVDF), poly(acrylic acid) (PAA) and sodium carboxymethyl cellulose (CMC).

In an embodiment, the surface modifier consists solely of carboxylic acid. Preferably, each carboxylic acid molecule has three or more carboxyl groups (i.e., —COOH group), e.g., citric acid (CA) or 1,2,3,4-butanetetracarboxylic acid (BA). In further embodiments, the carboxylic acid is selected from the group consisting of oxalic acid, trimesic acid, maleic acid, tartaric acid, and propane-1,2,3-tricarboxylic acid (PA), and combinations thereof.

In a feature of the invention, the silicon-based electrode active material is provided in the form of a plurality of micro-, or nano-structures, such as nanowires, nanotubes, hollow spheres, microparticles and nanoparticles. Microparticles are particles between 1 and 100 micrometers in size, and nanoparticles are particles between 1 and 100 nanometers in size.

Therefore, in a preferred embodiment, the resulting electrode has: an electrode active material comprising a silicon-based material coated in a carboxylic acid, a current collector and a binder adhering said electrode active material to said current collector. The carboxylic acid, in a preferred embodiment, covers more than 50%, or 80%, and more preferably about 100% (i.e., encapsulates), of the surface of the silicon-based material.

According to an aspect of the invention, a method for making the electrode of a lithium ion secondary battery includes steps as follow: (a) coating an electrode active material comprising a silicon-based material with a carboxylic acid, thereby chemically modifying the silicon-based material; and (b) adhering said coated electrode active material to a current collector using a binder. In one feature, step (a) results in silyl ester bonds on said silicon-based material, which functions as a pre-SEI that is further reduced, upon the initial charge, to form a protective SEI with lithium carboxylates.

### BRIEF DESCRIPTION OF DRAWINGS

FIG. 1 illustrates chemical structures of some carboxylic acids used to make various embodiments of the invention.

FIG. 2 shows digital photographs of a silicon-based electrode prepared with citric acid (Si-CA) (left side), and with 1,2,3,4-butanetetracarboxylic acid (Si-BA) (right side).

FIG. 3 shows the IR spectra for citric acid (bottom) and for silicon electrode with citric acid as both surface modifier and binder (top).

FIG. 4 shows voltage profile plots of Si-PVDF (a) and Si-CA (b) at different cycle numbers; capacity (c) and efficiency (d) vs. cycle number of Si electrode prepared with different binders in 1.2 M LiPF₆/EC:DEC+10 wt. % FEC.

FIG. 5 illustrates specific capacity of Si-Graphite composite with different carboxylic acids in 1.2M LiPF₆/EC:DEC (1:1,w/w)+10% wt. FEC. Capacity was calculated based on total weight of electrode excluding copper foil. Electrode loading was ˜3 mAh/cm².

FIG. 6 illustrates: (a) capacity retention vs. cycle number, (b) first dQdV plots, and (c) ATR FTIR spectra of silicon-graphite composite with citric acid as binder at different drying temperatures.

FIG. 7 schematically illustrates an embodiment of the invention where silicon nanoparticle's surface is modified using citric acid.

FIG. 8 shows FTIR-ATR spectra of pure silicon nanoparticles, pure citric acid powder and surface modified silicon nanoparticles.

FIG. 9 shows specific capacity, efficiency and capacity retention plotted against cycle numbers for cells containing silicon without (“Pure Si”) and with surface modification (“Mod Si”).

FIG. 10 shows specific capacity, efficiency and capacity retention plotted against cycle numbers for cells containing silicon-graphite composite electrodes, with or without surface modification.

### DETAILED DESCRIPTION OF THE INVENTION

As used in the specification and claims, the singular form “a”, “an”, or “the” includes plural references unless the context clearly dictates otherwise. For example, the term “a nanoparticle” includes a plurality of nanoparticles including mixtures thereof.

As used herein, “about” means within plus or minus 10%. For example, “about 1” means “0.9 to 1.1”, “about 2%” means “1.8% to 2.2%”, “about 2% to 3%” means “1.8% to 3.3%”, and “about 3% to about 4%” means “2.7% to 4.4%.”

Typically in a lithium ion secondary battery, a positive-electrode-active material or the like is coated on a current collector via a binder to obtain a positive electrode, and a negative-electrode-active material or the like is coated on the current collector via a binder to obtain a negative electrode. The electrode active material typically includes a material that intercalates or deintercalates lithium ions, and optionally a conductive auxiliary agent. The two electrodes are ionically connected to each other via an electrolyte layer that can be liquid or solid, and housed in a cell. A separator is provided to block electrons from flowing inside the battery cell. The binder adheres the negative electrode active material, typically as a layer, to a current collector, such as a metal foil (e.g., copper, steel, nickel, titanium, and alloys thereof). The current collector can be considered part of the electrode as well. In an alloy-based negative electrode, the negative-electrode-active material contains materials susceptible to form alloy with Li, such as silicon (Si), tin (Sn), aluminum (Al), or like materials such as silicon oxide. A more detailed description of lithium ion secondary battery can be found in US Patent Application Publication No. 20160141626, incorporated herein by reference.

As used herein, the term “silicon-based” electrode or material refers to a structure that includes silicon, silicon oxide (e.g., silicon dioxide), silicon compound, silicon-graphite composite, and other compositions having a significant amount of the silicon element, where silicon constitutes no less than 5%, 8%, or 10%, and more preferably, no less than 15% by molecular weight. Silicon may be present as elemental silicon, as an alloy or part of a compound, and two or more kinds thereof may be mixed for purpose of the present invention. The silicon compound may be specifically expressed as MₓSi (M is one or more elements other than Si, and x is a numeral of 0 or more), such as SiB₄, SiB₆, Mg₂Si, Ni₂Si, Ti₂Si, MoSi₂, NiSi₂, CaSi₂, CrSi₂, Cu₅Si, FeSi₂, MnSi₂, NbSi₂, TaSi₂, VSi₂, WSi₂, and ZnSi₂. Other examples of the silicon compound include a nitride compound and a carbide compound, such as SiC, Si₃N₄, Si₂N₂O, and LiSiO.

Silicon oxide can be represented, in formula, as SiO_{y} (0<y<2), and the oxidation number can be freely selected. Silicon oxide may be present alone or present in a state that silicon oxide is compounded with silicon, silicon alloy, or a silicon compound.

The negative electrode active material may be combined with a material that intercalates or deintercalates lithium ions other than silicon or silicon oxide as part of the electrode. Non-limiting examples thereof include graphite, soft carbon, hard carbon, TiO₂, Li₄Ti₅O₁₂, Fe₂O₃, and SnO.

The liquid electrolyte acts as a conductive pathway for movement of cations passing from the negative to the positive electrodes during discharge and vise versa during charge. The electrolyte in preferred embodiments of the present invention is a non-aqueous electrolyte solution where one or more lithium salts are dissolved in an organic solvent. Examples of the lithium salt that can be used include LiPF₆, LiClO₄, LiBF₄, LiCF₃SO₃, and LiBOB, any of which may be used alone or in combination of two or more thereof. Examples of the organic solvent include propylene carbonate, ethylene carbonate (EC), fluoroethylene carbonate, diethyl carbonate, dimethyl carbonate (DMC), and methylethyl carbonate. Any of these may be used alone or two or more of these may be mixed at any proportion and used. The organic solvent is preferably a mixture including a cyclic carbonate and a chained carbonate, e.g., EC mixed with DMC.

Binder material or organic solvents in the electrolyte can decompose on the negative electrode during the initial charge, and form a solid layer called solid electrolyte interphase (SEI), which can prevent further decomposition of binder or the electrolyte. As shown in the present invention, such a structure can also be used to protect and stabilize the silicon-based electrode, and effectively improve the battery's cycling performance.

Binder is not a simple inactive component that simply holds particle together but in fact can be incorporated into the SEI on silicon nanoparticle electrodes. Binders such as poly(acrylic acid) (PAA) and sodium carboxymethyl cellulose (CMC) can be uniformly coated onto surface of silicon nanoparticles during electrode preparation. The binders are then electrochemically reduced during formation cycling, producing a thin SEI (Nguyen, et al., 2016, supra). However, some electrolyte decomposition products are observed on Si-PAA and Si-CMC electrodes after the first cycle, and the concentration of electrolyte decomposition products becomes significant after 5 cycles (id.).

According to the present invention, better surface coverage of the Si-based particles is obtained with a small molecule surface modifier, preferably a carboxylic acid. This should increase the protection of silicon from the exposure to the electrolyte and improve cycling performance of Si-based anode. In a preferred embodiment, the surface modifier is a carboxylic acid. In a further preferred embodiment, the surface modifier to the anode is a carboxylic acid with three or more carboxyl groups (i.e., —COOH groups), e.g., citric acid (CA) or 1,2,3,4-butanetetracarboxylic acid (BA), with large concentrations of carboxylic acid and hydroxyl groups to foster strong interaction with silicon nanoparticles during electrode preparation by initially forming a precursor to an SEI (pre-SEI) and later participating in the formation of a full SEI upon interaction with the binder and electrolyte.

Thus, in a preferred embodiment, a more uniform layer of citric acid or its analogues covers the surface of a silicon-based nanoparticle as compared to conventional preparation (i.e., naked particles). This layer also undergoes an electrochemical reduction process, resulting in a carboxylic acid-derived SEI, which protects electrode from the electrolyte reduction in a similar fashion as observed with PAA. This SEI likely includes lithium carboxylates (e.g., lithium citrate) as a result of reduction of carboxylic acid by lithium-containing electrolyte. Because many carboxylic acids, such as citric acid and its analogues, are inexpensive, preferred embodiments of the invention have great potential for wide commercial adoption.

### EXAMPLES

In the present invention, we have utilized citric acid (CA) other carboxylic acids as a surface modifier to enhance the electrochemical cycling performance of Si-based nanoparticles. In some examples, CA was also used as a binder. Several other carboxylic acids have also been investigated and applied according to principles of the invention. Experimental procedures were as follows in an example unless otherwise specified:

Silicon nanoparticles (Alfa Aesar), super C (Timcal) and carboxylic acids (Acros) with a weight ratio of 50:25:25 were thoroughly mixed in a mortar and pestle for one hour using N-methyl-2-pyrrolidone (NMP) as solvent. The slurry was then transferred to a vial containing a magnetic stirring bar and stirred for 3 hours. The well mixed slurry was spread on a copper foil and dried in a convection oven at 60° C. Si electrodes with PVDF (M_{w}=600,000, MTI) and PAA (M_{w}=450,000, sigma-aldrich) binder also was prepared in the same way for reference. The electrodes were punched into 14 mm-diameter disks and dried in a vacuum oven at 110° C. for overnight. The dry electrodes were not calendared. The thickness of the electrode laminates were ˜15 μm (excluding copper foil) and the total material loading was ˜1.2 mg/cm² (0.6 mg/cm² for Si).

Battery grade solvents, salts and additives were received from BASF. Coin cells (2032-type) were assembled in an Ar-filled glovebox and used for evaluation of electrochemical cycling performance. The cells consist of a Si working electrode, a lithium foil counter electrode, electrolyte (100 μl) and separators (one Celgard 2325 and one glass fiber (GF/D, Whatman)). The electrolyte was 1.2M LiPF₆ in ethylene carbonate (EC): diethylene carbonate (DEC) (1:1, w/w) with 10 wt. % fluoroethylene carbonate (FEC). The cells were cycled between 0.005 and 1.5 Vat a rate of C/20 (0.179 A/g) for first cycle (formation cycle) and then C/7 (0.511 A/g) for additional cycles using an Arbin BT2000 battery cycler at 25° C. The rate was calculated based on the theoretical capacity of Si at 3579 mAh/g. Multiple samples for each electrode formulation were tested to confirm reproducibility.

About 0.2 g of citric acid was sonicated with 20 ml of N-methyl pyrrolidine (NMP) for 30 minutes to fully dissolve. Then the 0.2 g silicon nanoparticles were added and sonicated for 3 hours. This mixture was stirred for 12 hours using a magnetic stirrer and every 3 hours it was centrifuged and sonicated to prevent aggregation of particles. Subsequently the samples were centrifuged and excess NMP was removed. The particles were washed twice with NMP to remove any excess citric acid and washed with acetone 3 times to removes excess NMP and citric acid. The samples were dried under airflow in a convection oven for 2 hours and transferred into a vacuum oven at 350° C. and dried for 24 hours. The same procedure was repeated one more time to complete the surface modification. The samples were analyzed using Fourier transformation Infrared spectroscopy to confirm the formation of the silyl ester.

### Example 1. Interaction of Citric Acid with Silicon Nanoparticle and Electrode Preparation

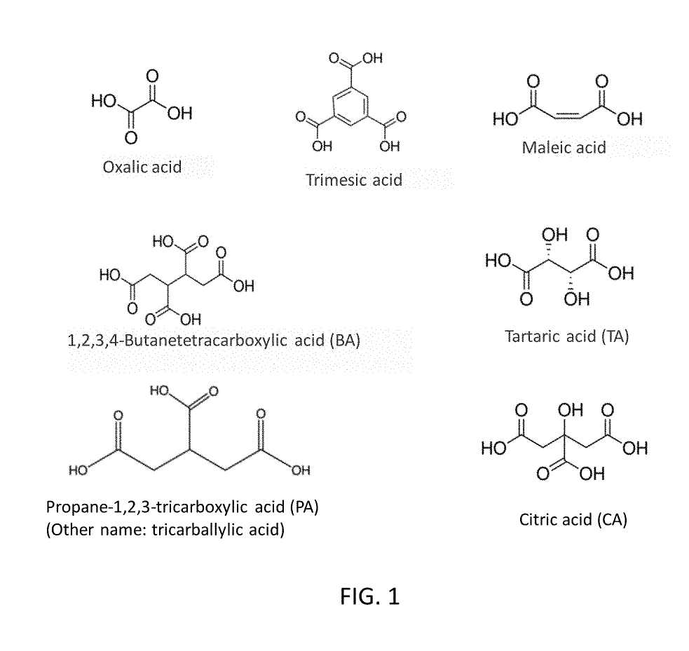

The structures of some examples of carboxylic acids that have been investigated in this work are depicted in FIG. 1.

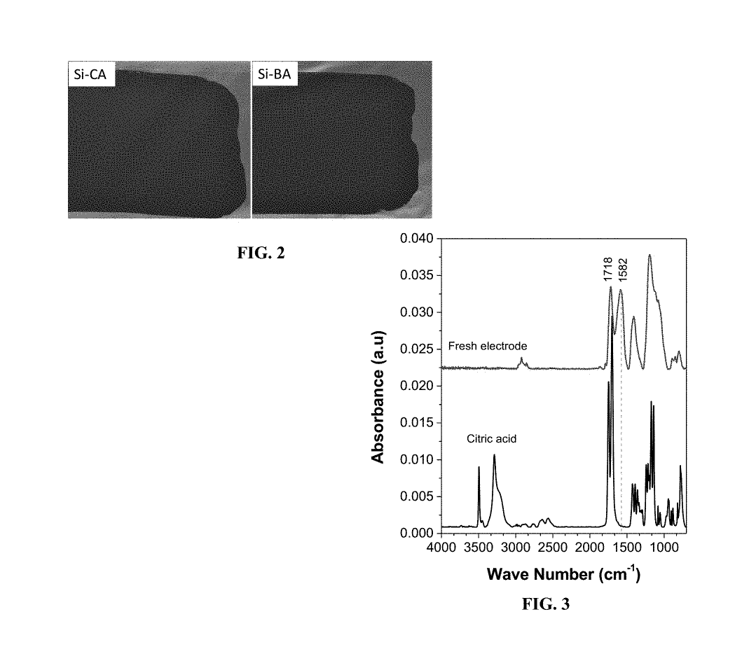

The mixing of NMP slurries with carboxylic acids having higher number of —COOH such as BA and CA yielded homogeneous electrode laminates (FIG. 2).

FIG. 3 presents ATR-IR of citric acid and Si electrode containing citric acid as both surface modifier and binder after drying at 110° C. Citric acid shows a sharp peak at 3500 cm⁻¹ and broad peak from 3400-3100 cm⁻¹, attributed to stretching and hydrogen bonding modes of —OH. At lower wavenumber, the double peaks at 1749 and 1700 cm⁻¹ are from —COOH groups. The absence of those bands and the appearance of a new peak at ˜1587 cm⁻¹ in the Si electrode with citric acid indicates that there were reactions between citric acid and silicon surface oxide and the silanol group at the surface of silicon nanoparticles, forming a silyl ester.

### Example 2. Cycling Performance of Si Nanoparticle with Carboxylic Acids as Both Surface Modifier Agent and Binder

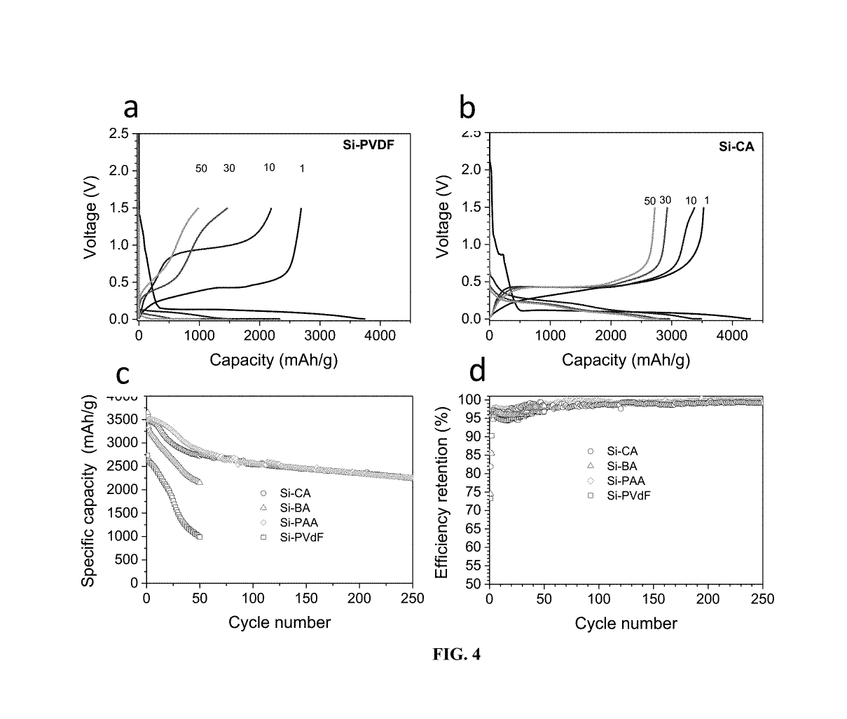

The plots of voltage profiles, capacity and efficiency vs. cycle number of Si-PVDF and Si-CA at different cycle numbers are presented in FIG. 4. Cycling data of Si-BA and Si-PAA are also added for reference. All electrodes contained 25 wt. % Super C as conductive carbon to ensure good electrochemical cycling performance as reported in literature. It has been reported that conductive carbon, i.e., super C, has an reversible capacity of about 180 mAh/g which is very low when compared to 3579 mAh/g for silicon. Thus, the specific capacity of silicon-based electrodes is mainly from silicon. The Si-PVDF shows a lithiation and delithiation capacity of 3750 and 2680 mAh/g (based on weight of silicon), respectively, corresponding to a first cycle efficiency of 71.4% (FIGS. 4a and 4c). The voltage profile for first cycle of Si-PVDF (FIG. 4a) shows several small plateaus from 1.4-0.8 V due to the reduction of electrolytes.

In addition, there is a large polarization in the voltage profiles as cycle number increases, indicating a significant increase of cell impedance. After 50 cycles, the Si-PVDF retains only ˜980 mAh/g after 50 cycles (FIGS. 4a and 4b), corresponding to a very poor capacity retention of 36.5%. On the contrary, the Si-CA has higher first cycle lithiation and delithiation capacity of 4300 and 3530 mAh/g, respectively, and a first cycle efficiency of 82% (FIGS. 4b, 4c and 4d). In the voltage profile curve of Si-CA (FIG. 4b), plateaus at ˜2 V and 0.8V could be due to the reduction of carboxylic/hydroxyl groups of CA and electrolyte reduction, respectively. Surprisingly, the Si-CA electrode maintains a capacity of 2200 mAh/g and a capacity retention of ˜64% after 250 cycles, similar to Si electrode prepared with long chain binder PAA (FIG. 4c). The electrode prepared with BA delivers an initial delithiation capacity of 3650 mAh/g and a first cycle efficiency of 75% (FIGS. 4c and 4d). After 50 cycles, the Si-BA cell retains a capacity of 2200 mAh/g and a capacity retention of 60%. While the rate of the capacity fade for the Si-BA cells is faster than the Si-CA cells, the Si-BA cells were still much better than Si-PVDF.

The superior performance of Si-CA compared to Si-PVDF suggests that the CA has an important role in enhancing cycling performance of Si electrode. Since CA is small molecule, its physical properties such as mechanical strength, adhesion and dispersion ability, which are considered as critical properties of binders for silicon anodes, might be not as good as the long chain PAA binder. However, the comparable cycling performance of Si-CA and Si-PAA suggests that other factor should be considered as a main contribution to the high performance of Si-CA. CA may uniformly cover the surface of Si due to the small molecular size and the strong interaction via a large number of carboxylic and hydroxyl groups. Therefore, it is reasonable to postulate that the improved electrochemical cycling performance is likely related to the SEI modification ability of citric acid.

3. Cycling Performance of Si-Graphite Composite with Carboxylic Acids as Surface Modifier Agent and Binder

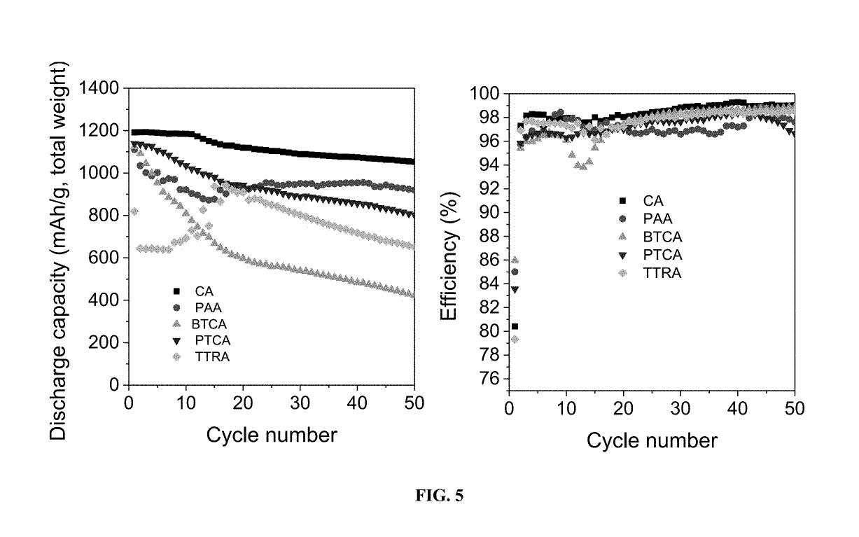

Composite of Si with graphite has been reported to have better cycling performance than pure silicon. Thus, we also investigated using carboxylic acid as a surface modifier of silicon before mixing silicon nanoparticles with graphite, and using CA as the binder for Si-graphite composite (FIG. 5). The electrodes were prepared with high loading at about 3 mAh/g. Among carboxylic acids, citric acid exhibits highest specific capacity and the most stable capacity retention and very good efficiency. It was surprising that cycling performance of Si-graphite with citric acid is even better than long-chain PAA binder without the use of CA.

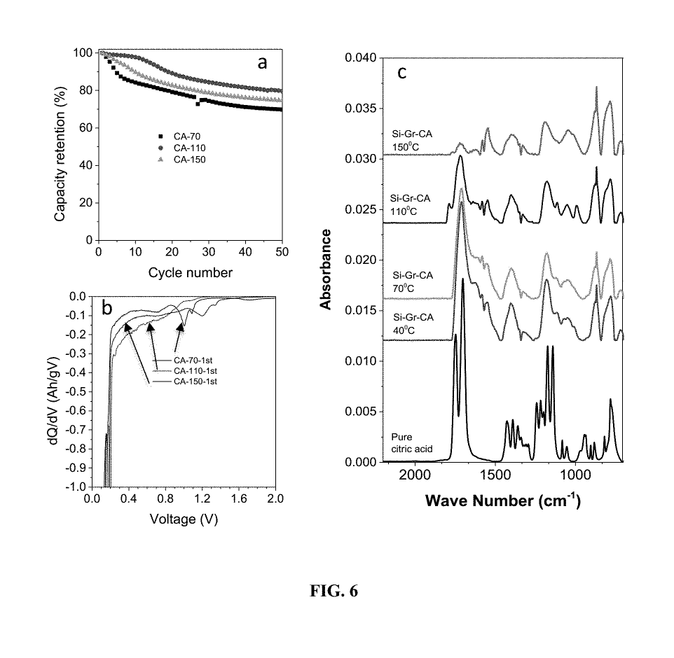

It was also found that the drying temperature strongly affects cycling performance of Si-graphite electrodes as shown in FIG. 6a. The electrode dried at 110° C. (the “CA-110” plotted line) appeared to have the best capacity retention. In the dQdV plot (FIG. 6b), electrodes dried at different temperatures had different curve shapes, indicating that the drying temperature altered the interfacial reaction of those electrodes. In IR spectra (FIG. 6c), the peak intensity and peak features changed as drying temperature increased. The weak signal of citric acid at 150° C. suggests that citric acid was decomposed at this temperature which may related to poorer performance compared to the one dried at 110° C. as shown in FIG. 6a.

4. Modifying Surface of Si NP Electrodes with Carboxylic Acids

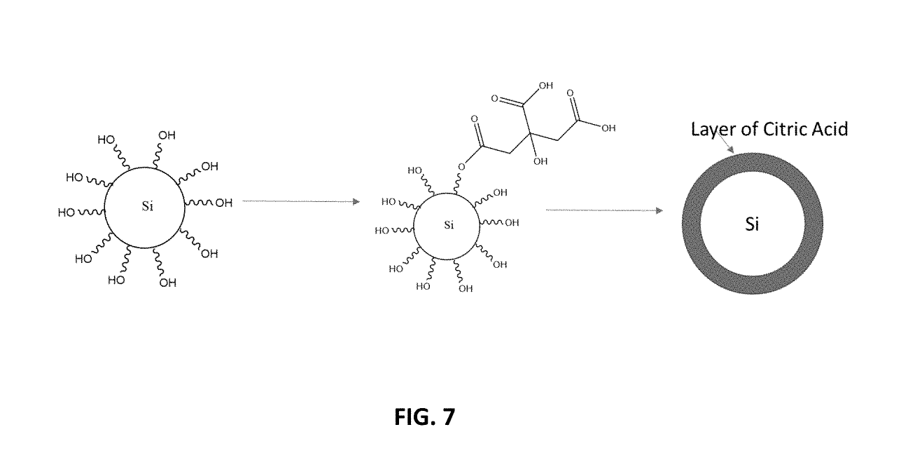

In addition being used as a binder, carboxylic acid such as citric acid can also be used as a surface-modifying agent on the silicon-based electrode active material. Reaction of silicon nano-particles with citric acid results in modification of the surface of the silicon-based nano-particle as depicted in FIG. 7. Specifically, electrodes containing surface-modified nanoparticles were prepared as follows:

Silicon nanoparticles (<50 nm, Alfa Aesar), Super C (Timcal), Graphite G8 (C-preme), SFG6 (Timcal), Anhydrous NMP (sigma Aldrich), PVDF binder (M_{w}=600 000, MTI) and Citric Acid (CA) (99.5%, Acros organics) were purchased. Battery grade Lithium hexafluorophosphate (LiPF₆), Ethylene Carbonate (EC), Dimethyl Carbonate (DMC) and Fluoroethylene Carbonate (FEC) were obtained from a commercial supplier with water content less than 50 ppm and stored in an Ar glovebox. High purity lithium chips (15.6 mm diameter) were purchased from the MTI Corporation.

Surface modification was carried out through sonication and subsequent stirring of silicon nanoparticles (Si-np) and citric acid in NMP. A sample of 10% citric acid solution was prepared through sonication of citric acid with NMP for 30 minutes. And 0.2 g of silicon nanoparticles were sonicated for three hours in 20 mL of the 10% citric acid-NMP solution. The mixture was stirred for 12 hours with 10 minutes of sonication every 3 hours to prevent aggregation of the nanoparticles. The particles were collected with centrifugal separation, washed twice with NMP to remove the unreacted citric acid, and washed 3 times with acetone to remove the residual NMP. The samples were dried under air at 40° C. in a convection oven for 2 hours and transferred to a vacuum oven at 35° C. and dried for 24 hours. The same procedure was repeated two more times to complete the surface modification. The samples were analyzed using infrared spectroscopy with attenuated total reflectance (IR-ATR) to confirm the formation of the silyl ester bonds.

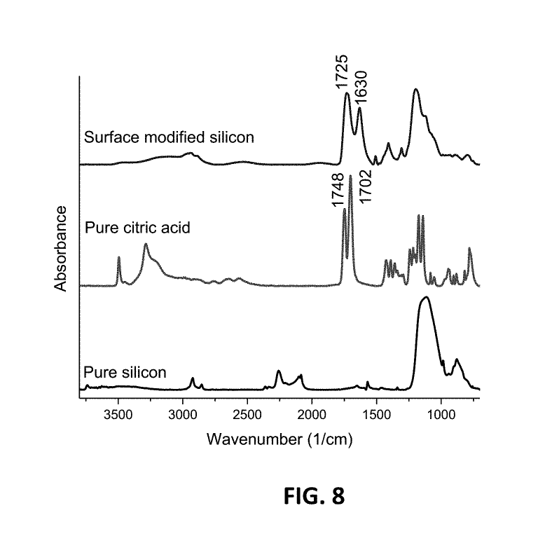

Specifically, the surface modified silicon nanoparticles were characterized using ATR-FTIR in a N₂ filled glovebox (or otherwise an oxygen-free or anoxic condition), prior to the preparation of electrodes to confirm the formation of the silyl ester. As shown in FIG. 8, pure citric acid shows peaks at 1749 and 1702 cm⁻¹ corresponding to the carboxylate carbonyl and C—O bonds. These two peaks were absent in the surface modified silicon nanoparticles indicating the absence of residual citric acid in the powder. The surface modified silicon spectra consist of two peaks in the same region but at 1725 and 1630 cm⁻¹. These two peaks as a pair indicates the formation of the silyl ester link (—Si—O—C(O)—C—) (Zhuang, G. V. et al., Electrochem. Solid-State Lett. 2005, 8, A441-A445). Pure silicon shows a couple of peaks in the range of 2000 to 2300 cm⁻¹ which are characteristic of Si—H, that cannot be seen in the surface-modified silicon, indicating that a reasonable area was covered by the surface modification.

The modified silicon nanoparticles were then used to prepare novel anodes with significantly better cycling performance than unmodified silicon nanoparticles. Specifically, laminates were prepared with both fresh silicon nanoparticles (“Si-np”) and modified silicon nanoparticles (“M-Si-np”). The electrode slurry was prepared in a nitrogen-filled glovebox or otherwise oxygen-free condition, to minimize agglomeration of the nanoparticles, oxidization in air, and reaction with moisture. The fresh Si-np or M-Si-np, super C65 conductive carbon, and PVDF binder were mixed thoroughly in 2:1:1 ratio using a mortar and pestle with extra dry NMP as a solvent. Citric acid, PVDF, graphite and carbon black powders, were dried in a vacuum oven overnight at 110° C., and Si-np powder was dried for 48 hours in a vacuum oven at 35° C. before slurry preparation.

Subsequently, the mixture was stirred for 3 hours using a magnetic stirrer and then coated on copper foil using a doctor blade. The laminates were dried in a convection oven under airflow for one hour and dried overnight under vacuum at room temperature. Electrodes were punched with 14 mm diameter and dried under vacuum at 110° C. for another 24 hours and transferred into an argon-filled glovebox for coin cell preparation.

Coin cells (2032 type) were constructed in an argon-filled glovebox. Cells were assembled using a 14 mm Si-np anode, one 19 mm Celgard 2325 separator, one 15.6 mm Whatman GF/D glass microfiber separator, and a 15.6 mm lithium chip with 100 μL of electrolyte containing 1.2M LiPF₆ in EC:DEC:FEC 40:40:10 (by mass). All Si-np∥Li cells were cycled between 0.005 and 1.50 V at a rate of C/20 for 1 formation cycle, with a C/40 taper charge followed by cycles at C/3 with a C/20 taper charge. Cell cycling was carried out with an Arbin BT 2000 battery cycler at 25° C. All cells were tested in triplicate. After the 1^{st} lithiation and 2^{nd} and 20^{th} delithiations, cells were rested for 12 hours followed by electrochemical impedance spectroscopy using a potentiostat with an amplitude of 10 mV and frequency range of 300 kHz-20 mHz.

Delithiated electrodes were extracted from the cycled cells, carefully rinsed with DMC three times (1.5 mL in total) to remove residual electrolyte and then dried in a glovebox for ex-situ surface analysis. Ex-situ X-ray photoelectron spectroscopy (XPS) was conducted using a K-Alpha spectrometer (Thermo Scientific) with a spot size of 400 μm, an energy step size of 0.05 eV, and a pass energy of 50 eV. The electrodes were transferred from the glovebox to the XPS chamber using a vacuum-sealed transfer module (Thermo Scientific) without exposure to air. The binding energy was corrected based on of C 1s peak of hydrocarbons at 285 eV. Infrared spectroscopy with attenuated total reflectance (IR-ATR) (Bruker Tensor 27 with LaDTG detector) was conducted inside a N₂-filled glovebox to prevent the reactions of samples with O₂ and moisture. All spectra were collected with 512 scans at a spectral resolution of 4 cm⁻¹.

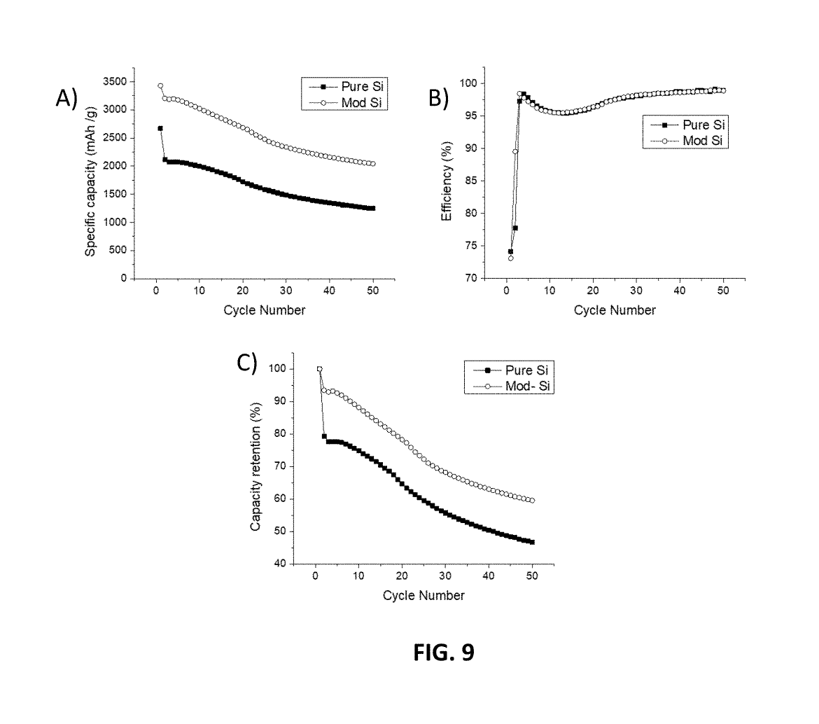

As shown in FIG. 9, the electrodes that contained surface modified silicon retained 60% of the initial capacity after 50 cycles as opposed to only 35% with the pure silicon electrodes. The first cycle efficiency is relatively similar but the capacity drop in the second cycle is about two to three times higher for cells with pure silicon compared to those with surface-modified silicon.

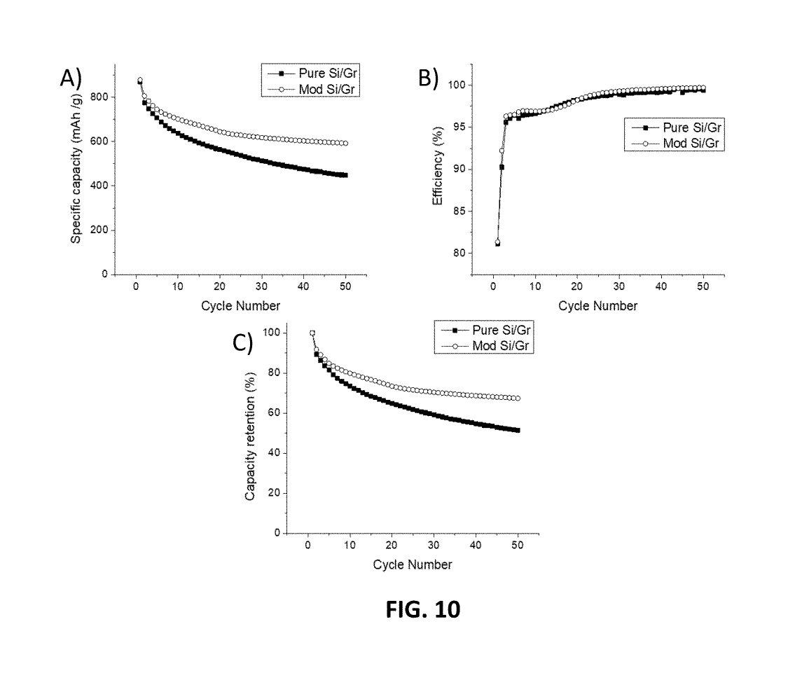

It was also found that the modified silicon particles could also be used in graphite-silicon composite to improve the capacity retention of a composite electrode. Similarly to CA-modified silicon nanoparticles described immediately above, nanoparticle graphite composite electrodes were prepared with Si-np or M-Si-np, Super C-65, Graphite SFG6, Graphite G8, and PVDF binder at a ratio of 15:5:30:40:10 using mortar and pestle using NMP as a solvent in a N₂ filled glovebox. As shown in FIG. 10, the cells containing the modified silicon show an improved capacity and more stable capacity retention as compared to the pure silicon containing electrodes. After 50 cycles cells with surface modified silicon has 800 mAh/g with about 70% capacity retention as opposed to the 500 mAh/g and 45% capacity retention in the pure silicon electrodes. Unlike in FIG. 4 the capacity drop into the 2^{nd} cycle is similar in the composite electrode. The pure silicon containing electrodes show a huge capacity fade over the 50 cycles but the surface modified silicon after 20 cycles show a reduction of the slope.

In sum, several carboxylic acids were investigated as functional SEI modifiers and, optionally, also binders for Si-based nanoparticle anodes. Si-CA electrodes have better capacity retention than Si-BA electrodes, but both electrodes outperform Si-PVDF. The Si-CA anodes have first cycle specific capacity and coulombic efficiency of ˜3530 mAh/g and 82%, respectively. After 250 cycles, Si-CA retains a high capacity ˜2200 mAh/g, corresponding to 64% capacity retention which is comparable to Si-PAA. The carboxylic acid layer uniformly covers the surface of Si-based nanoparticles due to strong interactions between the carboxylic acids and hydroxyl groups and the surface oxide, SiO_{y}, along with the orientational flexibility of the small molecule. The layer of lithium citrate derived from citric acid effectively stabilizes the surface of silicon-based particles. The modification and stabilization of the SEI by using citric acid and other carboxylic acids appear to be the main factor contributing to the enhancement of cycling performance of Si-based electrodes. The surface modification of silicon-based particles according to the invention is an efficient way to improve cycling performance of silicon-based, including Si-graphite composite, electrode.

While the present invention has been particularly shown and described with reference to the structure and methods disclosed herein and as illustrated in the drawings, it is not confined to the details set forth and this invention is intended to cover any modifications and changes as may come within the scope and spirit of the following claims. All publications and patent literature described herein are incorporated by reference in entirety to the extent permitted by applicable laws and regulations.

What is claimed is:

1. An electrode for a lithium ion secondary battery, comprising:
an electrode active material comprising a silicon-based material coated in a carboxylic acid;
a current collector; and
a binder adhering said electrode active material to said current collector.

2. The electrode of claim 1 wherein said electrode is a negative electrode.

3. The electrode of claim 1 wherein said silicon-based material is selected from the group consisting of silicon, silicon oxide, silicon compound, and mixture thereof.

4. The electrode of claim 1 wherein said carboxylic acid comprises citric acid.

5. The electrode of claim 1 wherein said carboxylic acid is selected from the group consisting of oxalic acid, trimesic acid, maleic acid, 1,2,3,4-butanetetracarboxylic acid, tartaric acid, and propane-1,2,3-tricarboxylic acid.

6. The electrode of claim 1 wherein said silicon-based material is in the form of nanoparticles or microparticles.

7. The electrode of claim 1 wherein said electrode active material further comprises graphite.

8. The electrode of claim 1 wherein said electrode active material further comprises a conductive auxiliary agent.

9. The electrode of claim 1, further comprising graphite mixed with said electrode active material.

10. The electrode of claim 1 wherein said binder is selected from the group consisting of poly(vinylidene difluoride) (PVDF), poly(acrylic acid) (PAA), and sodium carboxymethyl cellulose (CMC).

11. A lithium ion secondary battery comprising an electrode according to claim 1.

12. The lithium ion secondary battery of claim 11, further comprising a liquid electrolyte and a separator.

13. A method for making an electrode for a lithium ion secondary battery, said method comprising the steps of:
(a) coating an electrode active material comprising a silicon-based material with a carboxylic acid, thereby chemically modifying silicon-based material; and
(b) adhering said coated electrode active material to a current collector using a binder.

14. The method of claim 13, wherein said silicon-based material is provided in the form of nanoparticles or microparticles.

15. The method of claim 13, wherein step (a) resulting in silyl ester bonds on said silicon-based material.

16. The method of claim 13, wherein said electrode is a negative electrode.

17. The method of claim 13, wherein said silicon-based material is selected from the group consisting of silicon, silicon oxide, silicon compound, and mixture thereof.

18. The method of claim 13, wherein said carboxylic acid comprises citric acid.

19. The method of claim 13, wherein said carboxylic acid is selected from the group consisting of oxalic acid, trimesic acid, maleic acid, 1,2,3,4-butanetetracarboxylic acid, tartaric acid, and propane-1,2,3-tricarboxylic acid.

20. The method of claim 13, wherein said electrode active material further comprises graphite.
